(19) United States
(12) Patent Application Publication
(10) Pub. No.: US 2024/0154932 A1
(43) Pub. Date: May 9, 2024

(54) METHOD AND APPARATUS FOR OBTAINING USAGE INFORMATION OF USER TERMINAL

(71) Applicant: Fairy Inc., Seongnam-Si, Gyeonggi-Do (KR)

(72) Inventors: Jun Ho JANG, Seongnam-si, Gyeonggi-do (KR); In Sun JANG, Seongnam-si, Gyeonggi-do (KR); Ki Suk JANG, Seongnam-si, Gyeonggi-do (KR)

(73) Assignee: Fairy Inc., Seongnam-Si, Gyeonggi-Do (KR)

(21) Appl. No.: 18/398,840

(22) Filed: Dec. 28, 2023

Related U.S. Application Data
(63) Continuation of application No. PCT/KR2022/009306, filed on Jun. 29, 2022.

(30) Foreign Application Priority Data
Jun. 29, 2021 (KR) 10-2021-0084702
Feb. 28, 2022 (KR) 10-2022-0026342

(51) Int. Cl. H04L 61/4511

(52) U.S. Cl. CPC H04L 61/4511

(57) ABSTRACT

A method for operation of a user terminal, according to an embodiment of the present invention, comprises the steps of: registering a first address as DNS server information in a virtual private network (VPN) module; driving an application interworking with a target service server; acquiring domain name server (DNS) lookup request result information corresponding to the target service server by using the DNS server information; generating access domain information from the domain name server (DNS) lookup request result information; and outputting, on the basis of the access domain information, related useful information, such as user payment means-specific benefit notification corresponding to the application.

### CROSS-REFERENCE TO RELATED APPLICATIONS

The present application is a continuation of International Patent Application No. PCT/KR2022/009306, filed Jun. 29, 2012, which is based upon and claims the benefit of priority to Korean Patent Application No. 10-2021-0084702, filed on Jun. 29, 2021, and Korean Patent Application No. 10-2022-0026342, filed on Feb. 28, 2022. The disclosures of the above-listed applications are hereby incorporated by reference herein in their entirety.

### TECHNICAL FIELD

The present invention relates to a method of providing a service and an apparatus therefor. More specifically, the present invention relates to a method and apparatus for obtaining usage information of a user terminal.

### BACKGROUND ART

The number of customers who pay for purchases with cards rather than cash is increasing due to the inconvenience of carrying cash, credit card income deduction benefits, etc. In addition, as the number of card users increases and the card market expands, competition between card companies is intensifying. Therefore, card companies are releasing various types of card products that offer various benefits in order to encourage customers to sign up for cards, and multiple cards that offer different benefits are often issued to users.

Accordingly, recently, mobile credit cards that combine credit cards with mobile technology are being used for payments, and these existing mobile credit cards are issued through separate mobile card applications on credit card companies' customer centers and websites. In particular, models that store card information in a mobile terminal and perform payment processing through short-distance communication with a payment terminal or generation of a magnetic field signal have also been proposed, and are supported and serviced at various businesses.

However, as various payment methods appear, users are faced with much confusion and decision-making at the moment of payment. There are many things users need to know, such as various simple payments, local currency, membership discounts, credit card benefits, the previous month's performance, various point conditions, etc., there are many things users need to prepare, and there are many things users need to calculate in advance.

In order to improve such inconvenience, a technology for providing a recommendation card list in which order information of a user is collected and recommended cards suitable for the order information are displayed as a list is disclosed in the related art of Korean Patent Registration No. 10-1783708, and a technology in which a service server analyzes a recommended payment method and provides the analyzed recommended payment method to a mobile communication terminal is disclosed in Korean Patent Registration No. 10-1441288.

However, with the existing technologies as described above, the cards can only be recommended once the order details have been finalized or the actual payment has been made at the store, and thus there is a problem in that the time to make a choice and think about the card is short, which can actually add to the confusion and tension at the time of decision.

Accordingly, in terms of, before users decide to pay or order various benefits applicable to them, allowing the users to check in advance based on their situations, interests, and surrounding environments, and receive recommendations and choose appropriate products and optimal payment methods accordingly, the current payment methods still have many shortcomings.

### DISCLOSURE

### Technical Problem

The present invention is directed to providing a method and apparatus for obtaining usage information of a user terminal, in which network information among data processed by a user terminal is used to analyze current environment information of a user, select a target service and product content suitable for the analyzed current environment information, provide useful information related to the target service, such as payment method-specific benefit information in advance, or an optimal payment method for specific product content that is predicted to be currently needed by the user or the like, so that users can easily select appropriate product content and payment method from the corresponding service.

### Technical Solution

One aspect of the present invention provides an operating method of a user terminal, which includes registering a first address as domain name server (DNS) server information in a virtual private network (VPN) module; running an application linked to a target service server; obtaining DNS lookup request result information corresponding to the target service server using the DNS server information; generating access domain information from the DNS lookup request result information; and outputting related useful information, such as user payment method-specific benefit notification corresponding to the application on the basis of the access domain information.

Another aspect of the present invention provides a user terminal, which includes a VPN module configured to register a first address as DNS server information; and a control unit configured to run an application linked to a target service server, wherein the VPN module obtains DNS lookup request result information corresponding to the target service server using the DNS server information and generate access domain information from the DNS lookup request result information, and the control unit outputs related useful information, such as user payment method-specific benefit notification corresponding to the application on the basis of the access domain information.

Still another aspect of the present invention provides a benefit information provision device, which includes a communication unit configured to allow a user terminal to register a first address as DNS server information in a VPN module, run an application linked to a target service server, obtain DNS lookup request result information corresponding to the target service server using the DNS server information, generate access domain information from the DNS lookup request result information, identify target service information corresponding to a specific domain on the basis of the access domain information, and receive a request for user payment method-specific benefit information of the user terminal that is requested in response to the target service information; and a benefit information calculating unit configured to calculate user payment method-specific benefit information corresponding to the target service information using a pre-built payment method information database and benefit information database, wherein the communication unit transmits the calculated user payment method-specific benefit information to the user terminal.

Yet another aspect of the present invention provides a program for executing the above method on a computer, wherein the program may be implemented as a recording medium on which the program is recorded.

### Advantageous Effects

According to the embodiment of the present invention, based on domain name server (DNS) lookup request result information corresponding to a target service server that is obtained using DNS server information, user payment method-specific benefit notification information corresponding to a running application and web application service can be provided in real time.

Accordingly, according to the embodiment of the present invention, a method and apparatus for obtaining usage information of a user terminal, in which current environment information of a user is accurately analyzed as an application runs, a target service and product content suitable for the analyzed current environment information is selected, payment method-specific benefit information, such as an optimal payment method for specific product content that is predicted to be currently needed by the user or the like, is provided in advance, and the user can easily select appropriate product content and a payment method from the corresponding service, can be provided.

### DESCRIPTION OF DRAWINGS

FIG. 1 is a conceptual diagram schematically illustrating an entire system according to an embodiment of the present invention.

FIG. 2 is a block diagram for describing in more detail a user terminal according to an embodiment of the present invention.

FIG. 3 is a block diagram for describing a benefit information provision server according to an embodiment of the present invention.

FIG. 4 is a ladder diagram for describing the operation of an entire system according to an embodiment of the present invention.

FIG. 5 is a block diagram for describing an entire system according to another embodiment of the present invention.

FIGS. 6 and 7 are exemplary diagrams for describing implementation examples of a service interface according to an embodiment of the present invention.

FIG. 8 illustrates a payment system including the user terminal according to the embodiment of the present invention for using a shared payment method.

FIGS. 9 and 10 are exemplary diagrams for describing an implementation example of a service interface according to an embodiment of the present invention.

### MODES OF THE INVENTION

The following merely illustrates the principles of the present invention. Therefore, those skilled in the art will be able to invent various devices that embody the principles of the present invention and are included in the spirit and scope of the present invention, although not explicitly described or illustrated herein. Further, it should be understood that all conditional terms and embodiments listed herein are, in principle, expressly intended only for the purpose of ensuring that the concept of the present invention is understood, and are not limited to the embodiments and conditions specifically listed in this way.

Further, it should be understood that any detailed description reciting the principles, aspects and embodiments of the present invention, as well as specific embodiments, is intended to encompass structural and functional equivalents thereof. In addition, these equivalents should be understood to include not only currently known equivalents but also equivalents developed in the future, that is, all elements invented to perform the same function regardless of structure.

Therefore, for example, block diagrams herein should be understood as representing a conceptual view of an example circuit embodying the principles of the present invention. Similarly, all flowcharts, state transition diagrams, pseudo-code, and the like may be substantially represented on a computer-readable medium and should be understood as representing various processes performed by a computer or processor, whether or not the computer or processor is explicitly illustrated.

Functions of the various elements illustrated in the drawings, which include functional blocks represented by processors or similar concepts, may be provided by the use of dedicated hardware as well as hardware capable of executing software in conjunction with appropriate software. When the functions are provided by a processor, the functions may be provided by a single dedicated processor, a single shared processor, or multiple separate processors, some of which may be shared.

Further, any explicit use of terms such as processor, control, or similar concepts should not be construed as referring exclusively to hardware capable of executing software, and it should be understood to implicitly include, without limitation, digital signal processor (DSP) hardware, a read only memory (ROM), a random access memory (RAM), and a non-volatile memory for storing software. Other hardware for public use may also be included.

In claims of this specification, components represented as a method of performing the functions described in the detailed description include, for example, a combination of circuit elements that perform the functions or any form of software including firmware/microcode, etc., and are combined with appropriate circuitry for executing the software to perform the functions. Since the present invention defined by these claims combines the functions provided by various enumerated methods and is combined in the manner required by the claims, any method capable of providing the above functions should be understood as equivalent to those identified from this specification.

The above-described objects, features, and advantages of the present invention will be clearly understood through the following detailed description taken in conjunction with the accompanying drawings, and accordingly, those skilled in the art will be able to easily implement the technical idea of the present invention. Further, in descriptions of the embodiments of the present invention, when it is determined that detailed descriptions of known technology related to the present invention unnecessarily obscure the subject matter of the present invention, detailed descriptions thereof will be omitted.

Hereinafter, exemplary embodiments of the present invention will be described in detail with reference to the accompanying drawings.

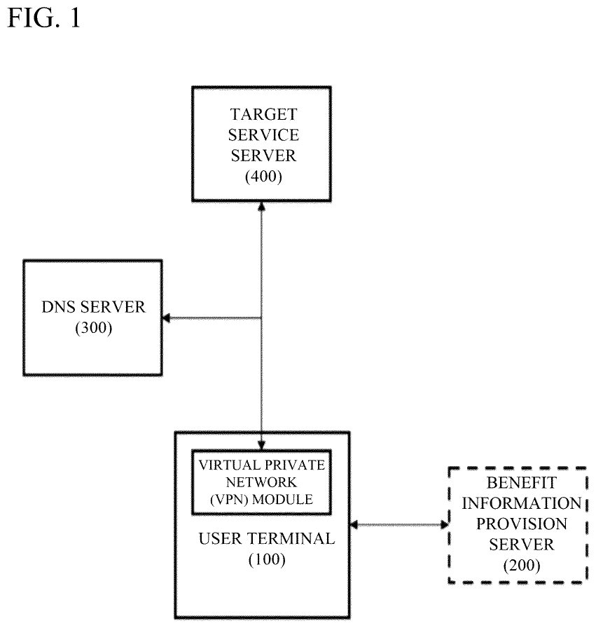

FIG. 1 is a conceptual diagram schematically illustrating an entire system according to an embodiment of the present invention.

The entire system according to the embodiment of the present invention includes a user terminal 100, a benefit information provision server 200, a domain name server (DNS) server 300, and a target service server 400.

First, the user terminal 100 may be a mobile terminal provided for each of users who use services, and may be operated by running an application running on each device. Accordingly, the user terminal 100 may include various terminals such as users' portable terminals, smartphones, tablet computers, and the like.

For example, the user terminal 100 may include either an individual terminal among a computer, a mobile phone, a smartphone, a smart pad, a laptop computer, a personal digital assistant (PDA), and a portable media player (PMP), or may be a control device that is implemented as a cloud computing device, a server device, or the like and outputs a screen and voice.

The target service server 400 may be a service server that is connected as the application of the user terminal 100 runs, and may include various service servers that provide information on services such as shopping, delivery, lodging, and the like.

The DNS server 300 may be a typical DNS server that processes a real Internet Protocol (IP) address response corresponding to domain name information requested by the user terminal 100, and may process a real IP address response corresponding to a DNS lookup request of the target service server 400 that is requested by the user terminal 100.

In addition, in the user terminal 100, a benefit information service may be registered through the benefit information provision server 200. Here, the benefit information provision server 200 may receive and manage terminal identification information of the user terminal 100, payment method information corresponding thereto, and customer information.

In order to register the benefit information service, the benefit information provision server 200 may check the customer information of the user terminal 100 and register the payment method information for providing benefit information for each target service corresponding to the customer information. Here, the customer information may include, for example, at least one of the payment method information, expiration date information, date of birth information, password information, payment method name authentication information, and terminal authentication information.

In addition, the user terminal 100 may include a virtual private network (VPN) module. In an embodiment of the present invention, the user terminal 100 may process conversion and encryption for communication with the target service server 400 using the VPN module, and in the process, the user terminal 100 may perform identification and notification processing of the target service server 400 using the domain name information obtained according to a separate identification process.

Further, the user terminal 100 may analyze the domain name information by performing packet conversion for identification and notification of the target service server 400, and the user terminal 100 may perform restoration, conversion, and transmission processes of an original packet in parallel so that normal communication with the target service server 400 can be maintained.

Accordingly, the operation of the VPN module according to the embodiment of the present invention may be processed inside the user terminal 100 or in an internal network, and may be processed regardless of the use of the target service server 400 of an external network.

The VPN module may be a pre-built module that is a component of the user terminal 100, but it is obvious that the VPN module may also operate as a separate server configured separately within an internal network.

More specifically, the user terminal 100 may register a first address as DNS server information in the VPN module.

In addition, when the user terminal 100 runs an application linked to the target service server 400, the user terminal 100 may use the DNS server information to obtain DNS lookup request result information corresponding to the target service server 400 from the DNS server 300 and generate access domain information from the DNS lookup request result information.

Here, the lookup request result information may include the first address that is the DNS server information for which the domain name information lookup has been requested, the domain name information for which the lookup has been requested, and IP address information as a DNS lookup request result.

Further, as the user terminal 100 restores the first address of the lookup request result information to an original address, connection and packet transmission or reception with the target service server 400 may be processed normally.

In addition, the user terminal 100 may use the lookup request result information to classify and process domains of packets transmitted to or received from a specific IP address into packets of the target service server 400 and generate the access domain information according to a classification frequency, number of times, or the like.

In addition, the user terminal 100 outputs related useful information, such as user payment method-specific benefit notification corresponding to the application on the basis of the access domain information.

According to such a system configuration, the user terminal 100 may directly and accurately identify a domain name of the target service server 400, which is accessed only when the application is actually used, in real time, without affecting application operation, and may analyze communication packets using the identified domain name information to generate the access domain information based on preset rules depending on the number or frequency.

Further, the user terminal 100 may request payment method-specific benefit information of the target service based on the access domain information from the benefit information provision server 200, and upon receiving a result of the request, the user terminal 100 may output the user payment method-specific benefit notification information corresponding to the application.

Accordingly, the user terminal 100 may output the user payment method-specific benefit notification information in real time according to various network operation environments such as shopping applications, lodging applications, web applications, and the like that the user accesses.

The user payment method-specific benefit notification information may be output, for example, as a popup message, displayed in the form of an icon, output in the form of a notification message, or output together with voice and vibration.

For example, when the user terminal 100 runs the Coupang application and is connected to the target service server 400, information on a discount rate on the Coupang service of the user's first payment card may be provided, and when the user terminal 100 runs the E-Mart application and is connected to another target service server 400, information on an accumulation rate of the user's second payment card accumulated through the E-Mart service may be provided.

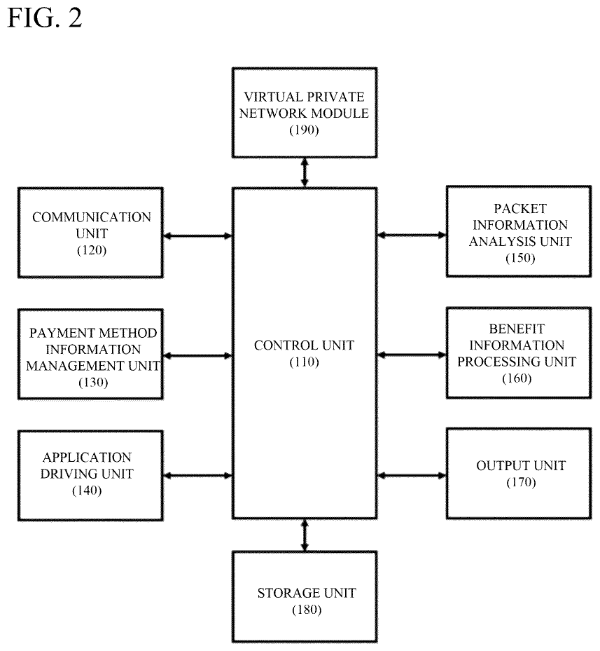

FIG. 2 is a block diagram for describing in more detail a user terminal according to an embodiment of the present invention.

Referring to FIG. 2, a user terminal 100 according to the embodiment of the present invention may include a control unit 110, a communication unit 120, a payment method information management unit 130, an application driving unit 140, a packet information analysis unit 150, a benefit information processing unit 160, an output unit 170, a VPN module 190, and a storage unit 180.

The communication unit 120 may include one or more modules that perform communication with external devices.

Here, the communication unit 120 may include a communication module that is connected in a wireless or wired manner through a local area network (LAN) and the Internet, a communication module that is connected through a Universal Serial Bus (USB) port or a mobile communication network such as the third or fourth generation of wireless mobile telecommunications technology, or a communication module that is connected through a short-range wireless communication method such as near-field communication (NFC), radio-frequency identification (RFID), Wi-Fi, or the like.

In addition, the payment method information management unit 130 may register, store, and manage payment method information of a user. Here, the payment method information may include, for example, cash card information, credit card information, online payment account information, payment quick-response (QR) code information, payment barcode information, etc., and furthermore, family sharing card information, another person's card information, etc. may also be registered and processed according to preset settings and authentication.

The application driving unit 140 may run an application according to user input. Here, the application may have various functions such as a web application, a delivery application, a shopping application, and the like, and examples of the application may include online applications that process the various functions according to communication with the target service server 400 according to the embodiment of the present invention.

Further, the application driving unit 140 may collect, store, and manage application processing data of the user.

For example, the application driving unit 140 may store and manage user location information, Wi-Fi connection information, web connection information, application execution information, payment record information, VPN connection information, etc. and at least some of the stored information may be transmitted to the VPN module 190 or the benefit information processing unit 160.

Meanwhile, the VPN module 190 may register a first address as DNS server information, and convert or restore a DNS lookup packet with the target service server 400 according to the application operation in the application driving unit 140.

In addition, the VPN module 190 may use the DNS server information to obtain DNS lookup request result information corresponding to the target service server 400 from the DNS server 300, generate access domain information from the DNS lookup request result information, and transmit the generated access domain information to the control unit 110.

More specifically, the VPN module 190 may configure a DNS lookup request packet to be requested from the DNS server 300, from the DNS server information, and obtain the DNS lookup request result information from the DNS server 300. In this case, the VPN module 190 may restore a source address of the DNS lookup request result information to an original address of the user terminal 100 from the DNS server information, and transmit the restored DNS lookup request result information to the application driving unit 140.

Accordingly, the application driving unit 140 may identify an IP address of the target service server 400 without any special problems, process packet transmission or reception to the identified IP address, and run the application.

In addition, the VPN module 190 may filter notification target domain information from the DNS lookup request result information.

Here, the VPN module 190 may provide the filtered notification target domain information to the packet information analysis unit 150 and allow the packet information analysis unit 150 to analyze the packet requested from the target service server 400 according to the application operation.

In addition, when the number or frequency of requests to a specific domain among the domains registered in the notification target domain information is greater than or equal to a threshold value, the packet information analysis unit 150 may generate the access domain information corresponding to the specific domain.

When the access domain information is generated, the benefit information processing unit 160 identifies target service information corresponding to the specific domain on the basis of the access domain information, requests user payment method-specific benefit information corresponding to the target service information from a pre-registered benefit information provision server 200, receives the user payment method-specific benefit information corresponding to the target service information from the benefit information provision server 200, and outputs the user payment method-specific benefit information through the output unit 170, under the control of the control unit 110.

For example, the benefit information processing unit 160 may display a related useful information, such as user payment method-specific benefit notification message on one side of a screen of the output unit 170 where the application is running, on the basis of the access domain information.

In addition, the user payment method-specific benefit notification information message may include one or more pieces of payment method information determined in response to the access domain information, among payment methods preset in the user terminal, for which product content payment benefits of the target service are present.

For example, when the Baedal Minjok app is run, a notification of the optimal payment method benefit according to the embodiment of the present invention may be displayed at the top of the screen. When the notification is selected, card and membership benefit information available in the currently running app may be provided on the screen, and the remaining benefits for this month for each card may be calculated and output. Such benefit information includes information that is calculated in advance by the benefit information provision server 200 and transmitted to the benefit information processing unit 160.

Further, when a taxi application service is used, the benefit information processing unit 160 may check benefit information related to taxi payment from the benefit information provision server 200 and display a notification corresponding thereto, and when the notification is selected, the benefit information processing unit 160 may process the optimal payment method and benefit information related to taxi payment to be output.

Further, at the time of accessing the Market Curly web, which is a shopping web page, benefit information configured in the benefit information processing unit 160 may be displayed at the top of the screen. To this end, the VPN module 190 according to the embodiment of the present invention may provide the operation of the application running in the background, and when the access information of the web application identified from the access domain information is Market Curly, the benefit information processing unit 160 may check the benefit information related to the Market Curly payment from the benefit information provision server 200, and the output unit 170 may display a notification corresponding thereto. When the notification is selected, the payment method-specific benefit information related to the Market Curly payment may be output.

Accordingly, the control unit 110 may use the benefit information processing unit 160 to allow the user payment method-specific benefit notification information corresponding to the application based on the access domain information to be output through the output unit 170.

Meanwhile, the processing operation of the control unit 110 may be processed according to the background operation of the user terminal 100, and the payment method-specific benefit information may be processed by outputting a notification message according to the foreground operation. Accordingly, the payment method-specific benefit information may be output through the output unit 170 in the form of a voice or text notification message.

Here, the foreground method is a service method in which an application is running on a memory of the storage unit 180 under the control of the control unit 110, and may be a method in which the operation of a running application is output through a screen interface on a display of the output unit 170. When the foreground execution is terminated, the application service may be terminated and may also be terminated on the screen. On the other hand, the background method may be a method in which even a running application may be executed and terminated without being displayed on the screen, and may be run without the user being aware of the application.

Meanwhile, the storage unit 180 stores and manages data required to provide the service according to the embodiment of the present invention.

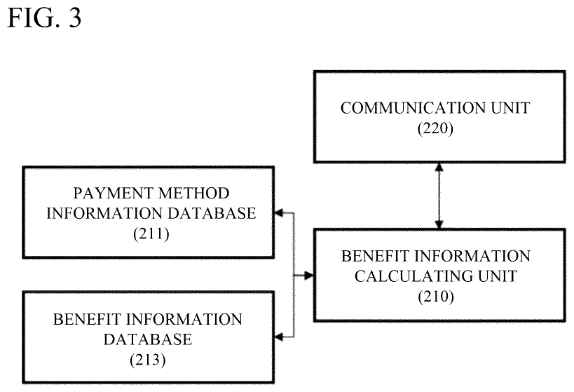

FIG. 3 is a block diagram for describing a benefit information provision server according to an embodiment of the present invention.

Referring to FIG. 3, a benefit information provision server 200 according to the embodiment of the present invention includes a communication unit 220 and a benefit information calculating unit 210, and the benefit information calculating unit 210 includes a payment method information database 211 and a benefit information database 213.

The communication unit 220 receives a payment method-specific benefit information request from a user terminal 100.

More specifically, the communication unit 220 may allow the user terminal 100 to register a first address as DNS server information in a VPN module, run an application linked to a target service server, obtain DNS lookup request result information corresponding to the target service server using the DNS server information, generate access domain information from the DNS lookup request result information, identify target service information corresponding to a specific domain on the basis of the access domain information, and receive a user payment method-specific benefit information request of the user terminal requested in response to the target service information.

In addition, the benefit information calculating unit 210 calculates the user payment method-specific benefit information corresponding to the target service information using the pre-built payment method information database 211 and benefit information database 213.

In addition, the communication unit 220 transmits the calculated user payment method-specific benefit information to the user terminal 100.

The benefit information provision server 200 may communicate with a preset financial institution, a card company server, or the like, and may be a server that updates and manages the payment method information database 211 and the correspondingly mapped benefit information database 213 in real time or at regular intervals.

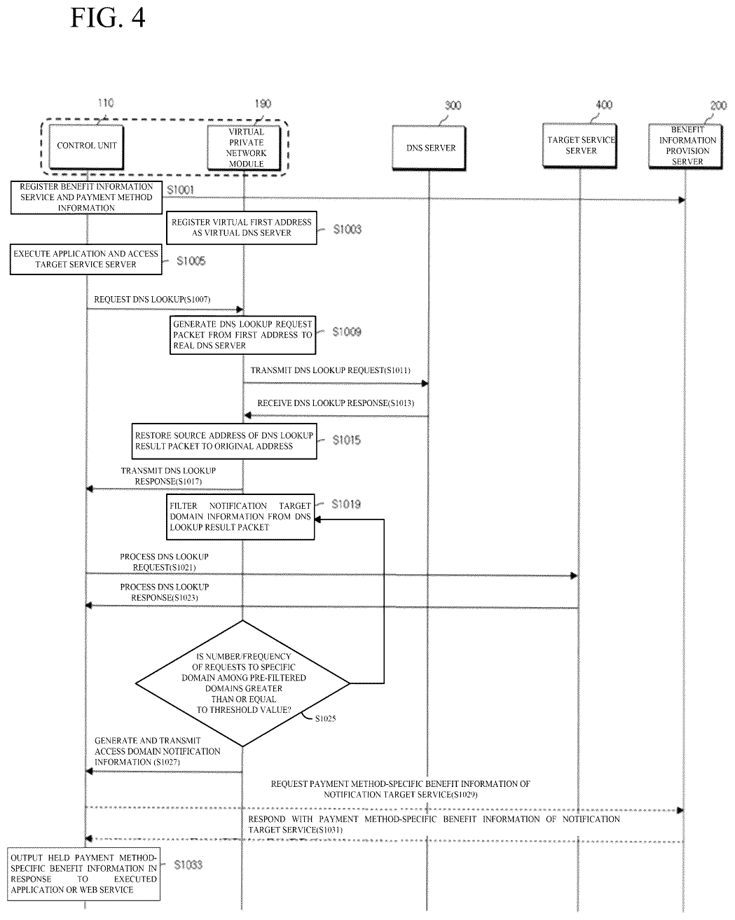

FIG. 4 is a ladder diagram for describing the operation of an entire system according to an embodiment of the present invention.

Referring to FIG. 4, first, a control unit 110 registers a benefit information service and payment method information in a benefit information provision server 200 (S1001).

In addition, a VPN module 190 registers a virtual first address as a DNS server (S1003).

Thereafter, the control unit 110 attempts to execute an application and access a target service server through an application driving unit 140 (S1005).

When a User Datagram Protocol (UDP) packet containing a DNS lookup request for server connection is identified (S1007), the VPN module 190 converts and generates a DNS lookup request packet from the first address to a DNS server 300 (S1009).

In addition, the VPN module 190 requests a DNS lookup through the DNS server 300 (S1011) and receives a DNS lookup response corresponding to the request from the DNS server 300 (S1013).

Thereafter, the VPN module 190 restores a source address of the DNS lookup result packet to an original address of the user terminal 100 (S1015), and the restored DNS lookup result packet is transmitted to the application driving unit 140 through the control unit 110 (S1017).

In addition, the VPN module 190 filters notification target domain information from the DNS lookup result packet (S1019).

Here, the notification target domain information may be mapped and filtered for each preset target service. For example, the notification target domain information may be classified and processed like aaa.com representing a delivery service, bbb.com representing b hotel reservation service, ccc.com representing c taxi service, and the like.

Thereafter, the control unit 110 processes a service information request and response with the target service server 400 using IP address information identified using the restored DNS lookup result packet, and runs the application (S1021 and S1023).

Here, the service information request and response with the IP address information may be further performed using Transmission Control Protocol (TCP)/IP packets.

According to such operation, the VPN module 190 determines whether the number or frequency of IP packet requests to a specific domain among pre-filtered domains is greater than or equal to a threshold value, through the packet information analysis unit 150 (S1025). When it is determined that the number or frequency of IP packet requests to the specific domain is less than the threshold value, filtering and packet analysis may be performed continuously.

On the other hand, when it is determined that the number or frequency of IP packet requests to the specific domain is greater than or equal to the threshold value, the VPN module 190 generates the access domain information and transmits the generated access domain information to the control unit 110 (S1027).

According to this processing, domain information analysis and target service domain filtering according to UDP packet analysis of DNS request information may be processed primarily, the target service may be secondarily determined according to the subsequent analysis of the number or frequency of TCP/IP packet requests, and thus its accuracy may be improved.

Here, the access domain information may include notification setting information for setting a specific target service provided by the domain identified from the packet as a notification target service.

Accordingly, the control unit 110 requests payment method-specific benefit information of the notification target service to the benefit information provision server 200 through the benefit information processing unit 160 (S1029), and the benefit information provision server 200 provides the payment method-specific benefit information of the requested notification target service as a response to the benefit information processing unit 160 (S1031).

Thereafter, the control unit 110 outputs the held payment method-specific benefit information in response to the application or web service already executed in the foreground, through the output unit 170 (S1033).

Meanwhile, the request and transmission processes in operations S1029 and S1031 described above are not essential, and the process of identifying the payment method-specific benefit information of the notification target service may be processed without a separate request or response, through the benefit information processing unit 160 of the control unit 110.

In this case, the benefit information processing unit 160 may pre-store and manage a benefit information database for each payment method according to the target service in the storage unit 180 of the user terminal 100, and identify the payment method-specific benefit information of the notification target service described above using the pre-stored benefit information database for each payment method according to the target service. When such a process is present, the benefit information provision server 200 may provide the benefit information database pre-built for each payment method to the user terminal 100.

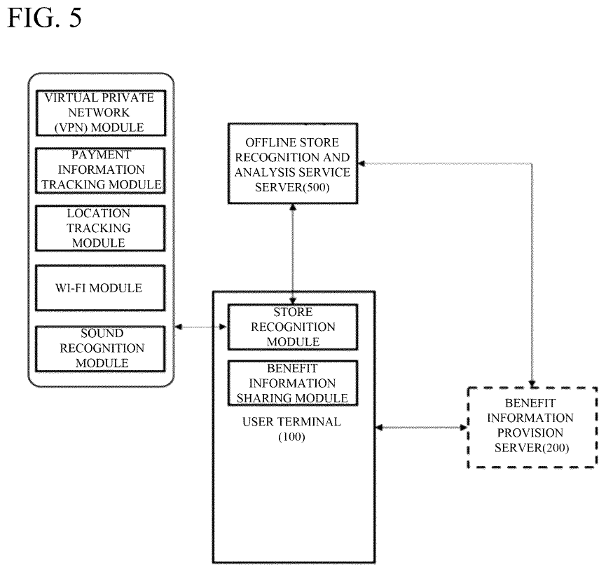

FIG. 5 is a block diagram for describing an entire system according to another embodiment of the present invention.

Referring to FIG. 5, the entire system according to another embodiment of the present invention may further include an offline store recognition and analysis service server 500 that identifies an offline store located near a user terminal 100 and outputs payment method-specific benefit information corresponding to the identified offline store using a store recognition module of the user terminal 100 according to the embodiment of the present invention.

Here, the offline store recognition and analysis service server 500 may be linked to the store recognition module provided in the user terminal 100 to recognize the offline store located near the user terminal 100 and provide a data sharing service based on information on the recognized store.

To this end, the user terminal 100 may include a store recognition module for offline store recognition. The store recognition module may include the above-described VPN module. Further, the store recognition module may collect and manage various pieces of environment information for offline store recognition. Such a store recognition module may include at least one of the VPN module, a payment information tracking module, a location tracking module, a Wi-Fi module, and a sound recognition module.

The payment information tracking module may collect and manage payment messages or benefit application record messages transmitted or received through the user terminal 100 for offline store recognition.

The location tracking module may track location information of the user terminal 100 for offline store recognition. For example, the location tracking module may be an example of a Global Positioning System (GPS) module.

The Wi-Fi module may collect and manage signal strength information such as service set identifier (SSID) information and received signal strength indication (RSSI) of a Wi-Fi access point (AP) connected to the user terminal 100 for offline store recognition.

The sound recognition module may collect and manage sound characteristic information collected from a microphone provided in the user terminal 100 for offline store recognition.

Accordingly, the user terminal 100 may transmit the information collected by the store recognition module to the offline store recognition and analysis service server 500, the offline store recognition and analysis service server 500 may identify the offline store on the basis of the collected information, and the identified offline store information may be transmitted to the benefit information provision server 200 and the user terminal 100.

Further, for example, the store recognition module may identify the offline store by combining the information collected by the Wi-Fi module and the information collected by the sound recognition module. In this case, the store recognition module may collect specific store identification information and Wi-Fi SSID information matching the specific store identification information from the offline store recognition and analysis service server 500, and receive and pre-store store and payment method-specific benefit information corresponding to the specific store identification information from the benefit information provision server 200.

In addition, the user terminal 100 may collect surrounding Wi-Fi SSID information through the Wi-Fi module and collect ambient sound characteristic information through the microphone of the sound recognition module. Here, the sound recognition module may identify current in-store sound environment information of the user using an artificial intelligence model in which offline store-specific sound environment information corresponding to the sound characteristic information is pre-learned. For example, the sound recognition module may identify whether the user has entered a coffee shop or is outside the coffee shop on the street.

In addition, the user terminal 100 may use the Wi-Fi SSIDs, the output information of the sound recognition module, and the information previously received from the offline store recognition and analysis service server 500 and stored to recognize which store the user of the user terminal 100 has entered, through the store recognition module, check payment method-specific benefit information to be applied to the user at the store that the user has entered, and output the checked payment method-specific benefit information through the output unit 170.

Meanwhile, the store recognition module of the user terminal 100 may process various pieces of environmental information corresponding to the store as learning input values, along with the sound information collected from the store, in order to learn the above-described artificial intelligence model, and the learning input values may further include sound characteristic information, Wi-Fi identification information, and a payment text message or notification information that is collected by the payment information tracking module.

For example, the user terminal 100 may identify a payment text message or a payment notification through the payment information tracking module, at the time of payment recognition according to the payment notification, the Wi-Fi module may collect the surrounding Wi-Fi SSID information, and at the same time, the sound recognition module may collect the ambient sound characteristic information.

In addition, the user terminal 100 may configure snapshot data combining the surrounding Wi-Fi SSID information and sound characteristic information as learning data in response to the payment text message or payment notification, and the learning data is transmitted to the offline store recognition and analysis service server 500 and processed to be used to identify the offline store. Here, the learning data may be used to train an artificial intelligence learning model trained by a correlation learning algorithm such as a convolutional neural network (CNN), a deep neural network (DNN), or the like. Accordingly, accuracy training and advancement of various environmental recognition-based offline store recognition functions may be achieved.

In addition, the user terminal 100 may identify the payment method-specific benefit information identified in response to the offline store through the benefit information processing unit 160 and output the payment method-specific benefit information through the output unit 170.

For example, the user terminal 100 may identify at least one of a specific affiliated store Wi-Fi SSID, a payment short message service (SMS), location information, and sound characteristic information through the store recognition module, identify the payment method-specific benefit information based on the offline store recognition corresponding to Wi-Fi of a specific affiliated store, a specific payment SMS, a specific location, and specific sound characteristic information, and perform notification processing through the output unit 170.

For example, when there is a payment method provider affiliated store that provides benefits to the user near the user terminal 100, discount/benefit information may be output on the screen of the user terminal 100 in the form of an automatic notification.

To this end, the user terminal 100 according to the embodiment of the present invention may perform the following procedure.

The user terminal 100 may receive benefit information of a payment method registered by the user from a server through the benefit information processing unit 160.

The user terminal 100 may collect SSIDs corresponding to Wi-Fi APs of nearby stores, collect sound characteristic information, collect payment SMS information, or collect location information, through the Wi-Fi module of the store recognition module.

In addition, the user terminal 100 may identify an offline store using at least one of the SSID information, the sound characteristic information, the payment SMS information, and the location information through the store recognition module. To this end, the store recognition module may transmit at least one of the SSID information, the sound characteristic information, the payment SMS information, and the location information to the offline store recognition and analysis service server 500, and receive store identification information as an analysis result from the offline store recognition and analysis service server 500.

In addition, the user terminal 100 may receive the benefit information by providing the store identification information to the benefit information provision server 200, or when there is a benefit applicable to the payment method registered by the user through the benefit information processing unit 160, the user terminal 100 may output a screen notification using the output unit 170.

Here, the Wi-Fi module may further perform filtering to extract only SSIDs identified with a certain intensity for a certain period of time or more among the Wi-Fi SSIDs. Through the filtering, it is possible to prevent stores not intended by the user from being displayed.

Further, the user terminal 100 may output each piece of payment method-specific discount benefit information when the benefit information processing unit 160 outputs a notification, and when the user enters a notification selection, the user terminal 100 may control more detail benefit information to be received from the benefit information provision server 200 and be output.

Meanwhile, the offline store recognition and analysis service server 500 may manage, in a database, affiliated store identification information corresponding to at least one of the specific SSID information, the specific sound characteristic information, the specific payment SMS information, and the specific location information and payment method provider information corresponding to the affiliated store identification information.

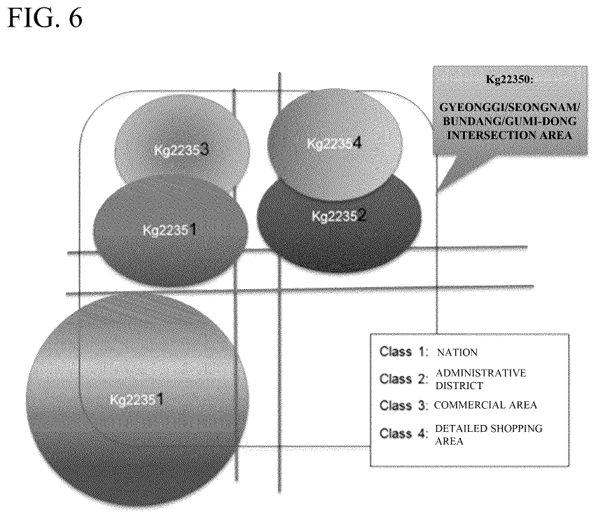

FIG. 6 is a diagram for describing a method of registering offline affiliated store Wi-Fi identification information.

Referring to FIG. 6, the user terminal 100 according to the embodiment of the present invention may pre-register and manage Wi-Fi identification information for providing a payment benefit service based on location through a Wi-Fi module of the store recognition module.

In particular, for franchises and large-scale stores with unified Wi-Fi identification information, the user terminal 100 according to the embodiment of the present invention may pre-register the Wi-Fi identification information of the corresponding store.

However, among franchises with unregistered Wi-Fi identification information, there are many stores that do not have uniform Wi-Fi identification information or have Wi-Fi identification information that is difficult to identify, and thus, in order for the user terminal 100 according to the embodiment of the present invention to distinguish between such stores, a procedure for registering store-specific Wi-Fi identification information is required.

That is, in the case of a specific franchise benefit affiliated store, the user terminal 100 according to the embodiment of the present invention may use clearly distinguishable Wi-Fi identification information for each affiliated store to easily register the Wi-Fi identification information in the app and show the benefits by distinguishing the Wi-Fi identification information when visiting the store.

However, in most benefit affiliated stores, the Wi-Fi identification information is arbitrarily set by the store owner, and many of the benefit affiliated stores use the name given by the Wi-Fi repeater company, such as iptime and KT wifi 1234.

Therefore, on the streets of areas where stores are concentrated, multiple Wi-Fi signals with the same Wi-Fi identification information are displayed, and in reality, the user has to go to a specific store in the area to identify the Wi-Fi with the strongest signal, and in most cases, when the user has logged in once, the user will be logged in automatically.

With reference to these matters, the user terminal 100 according to the embodiment of the present invention may distinguish which payment method benefit affiliated store the store that the user terminal has entered is based only on the Wi-Fi identification information determined by the store owner.

To this end, the user terminal 100 according to the embodiment of the present invention may selectively perform the following process.

(A) User direct input service: When a user visits a store where Wi-Fi is not registered in the user terminal 100 according to the embodiment of the present invention, the corresponding store's Wi-Fi may be registered in the user terminal 100 according to the embodiment of the present invention, and benefits for each payment method provider received by the store that owns the Wi-Fi identification information should be able to be stored within the user terminal 100 according to the embodiment of the present invention.

\textcircled{1} Registration service for Wi-Fi identification information: A system for registering store-specific Wi-Fi identification information with a unique name is provided.

For example, when Wi-Fi identification information called iptime or KT wifi 1234, which is commonly used by the Paris Baguette stores in Bundang, is used, the user may give a new name to the Wi-Fi identification information, such as “Paris Baguette Bundang Gumi Branch,” so that an identification (ID) for a Wi-Fi signal is displayed with the new name when the user visits or passes nearby.

In this case, the user terminal 100 according to the embodiment of the present invention may provide a user interface (UI) that facilitates new name registration. For example, just typing the word “Paris” through the UI may output the related Paris Baguette, and when Paris Baguette is selected, the user terminal 100 according to the embodiment of the present invention may provide an application that reads GPS and displays the corresponding GPS information and the name of the Paris Baguette branch nearby.

In this case the user terminal 100 according to the embodiment of the present invention may store and manage Wi-Fi identification information (ip time) determined by the store owner, Wi-Fi identification information (Paris Baguette Bundang-Gumi branch) determined by the user, and various pieces of identification information related to Wi-Fi repeaters.

\textcircled{2} Shop name payment method provider affiliate list registration service: When the user inputs the corresponding store name, a name of the store input by the user and a name of the affiliated store used internally by the payment method provider may be different, and thus the user terminal 100 according to the embodiment of the present invention may provide a process for mapping the names. Since the user input Tom & Toms, but the payment method provider may use various other names internally, such as Tom and Toms, Tom & Toms, and Tom & Toms coffee, the user terminal 100 according to the embodiment of the present invention may provide a registration service reflecting the above fact.

(B) User terminal 100 input service: The user terminal 100 according to the embodiment of the present invention may provide a direct input service focusing on important franchises.

(C) Shop owner input service: The user terminal 100 according to the embodiment of the present invention provides a function for allowing store owners to easily change Wi-Fi identification information. It is designed to be significantly differentiated from nearby store Wi-Fi identification information so that the user can easily distinguish the Wi-Fi identification information. In this case, in the case of franchises, the user terminal 100 according to the embodiment of the present invention may provide a list of branch names to the store owner.

(D) ID expression method additional service: The user terminal 100 according to the embodiment of the present invention may provide a function for adding various decoration expressions to the Wi-Fi identification information (name). An emoticon or the like indicating the store may be added to the Wi-Fi identification information.

Payment Information-Based Affiliated Store Basic Information Registration Service

The user terminal 100 according to the embodiment of the present invention may provide a payment information-based affiliated store basic information registration service when the user visits a specific store with Wi-Fi and makes a payment.

(A) The user terminal 100 according to the embodiment of the present invention may determine GPS location/Wi-Fi repeater-related information of the corresponding store, and the user terminal 100 according to the embodiment of the present invention may identify a store name/payment item/store Wi-Fi name from a payment notification message transmitted to the mobile terminal of the user.

(B) GPS zone class code service: The user terminal 100 according to the embodiment of the present invention statistically analyzes usage information of many users and stores and manages the analysis information for the corresponding store.

The user terminal 100 according to the embodiment of the present invention stores data such as a store name, a GPS standard value, a Wi-Fi name set by the store owner, an internally used name for each store by credit card company, and the like.

Further, when a GPS zone class code is assigned to the corresponding store, the user terminal 100 according to the embodiment of the present invention analyzes and determines Wi-Fi signal characteristics for each time slot in which the users pay. In particular, stores located on a regional boundary of the GPS zone class may have multiple GPS zone class codes, which can be referenced and reflected in decisions.

(C) Default Wi-Fi name service: The user terminal 100 according to the embodiment of the present invention may designate a default name for the corresponding store Wi-Fi on the basis of user payment notification message information.

Meanwhile, FIG. 6 illustrates a Wi-Fi identification information coding method according to an embodiment of the present invention. Referring to FIG. 6, the user terminal 100 according to the embodiment of the present invention may assign a Wi-Fi ID code according to various features as follows through internal Wi-Fi identification information coding.

(A) GPS zone code: G-zone code, based on the standard for assigning one GPS zone code per 100 people, the entire country is divided into approximately 500 to 1 million zones depending on administrative districts, population, and commercial density, and numbers are assigned to the divided zones.

FIG. 6 illustrates an example of GPS zone coding, and when one store is close to the border of a GPS zone, the GPS zone code may have multiple values.

(B) Commercial common name code: Call name code, examples include commercial names commonly called by users, for example Tom&Toms and the like.

(C) Brand code using payment method provider: Brand name code, one or several brand names of affiliated stores used within payment method providers, for example, Tom and Toms, Tom & Toms Coffee, Tom & Toms, Tom & Toms Coffee, etc., may be used as a list of payment method provider affiliated stores.

(D) Payment method provider registration branch code: Branch point code, a franchise may have dozens to thousands of locations, and a stand-alone store may have one location.

(E) Wi-Fi ID code dedicated to the user terminal 100 according to the embodiment of the present invention: Examples include Kg22351-cn1355-bn8765-bp0355 and the like.

Kg22351: Kg Gyeonggi-do, Seongnam-si (2) Bundang-gu (2) Gumi-dong (3) Gumi-dong intersection (5) south.west (1), GPS Zone Code.

cn1355: call name, common name code such as Paris Baguette bn8765: brand name, brand name, name code for each payment method provider that refers to a franchise, such as Paris Baguette/Paris Baguette/Paris Baguette Cafe.

bp0355: branch point Franchise branch name, Paris Baguette Gumi branch in Gumi-dong, Bundang-gu, etc.

Based on the Wi-Fi identification information coding method described above, the user terminal 100 according to the embodiment of the present invention may be operated as follows when visiting a specific area (G-Zone).

GPS Zone Service Operation

The user terminal 100 according to the embodiment of the present invention reads a GPS signal and calculates a G-Zone Code. A list of affiliated stores that belong to the corresponding G-Zone Code and have benefits is extracted from among the cards registered by the user.

When the mobile terminal of the user receives a Wi-Fi signal within a specific G-Zone Code and a movement speed of the user is low (when the user is not walking or in a vehicle), a list of payment methods with benefits among those within the GPS Zone Class is output on the mobile terminal.

The user terminal 100 according to the embodiment of the present invention may sort names of stores that have experience using the user terminal 100 according to the embodiment of the present invention in the corresponding area at the top of the screen.

Further, depending on the user's selection, the user terminal 100 according to the embodiment of the present invention may output a benefit affiliated store as an example within the G-Zone even when the Wi-Fi signal is not available.

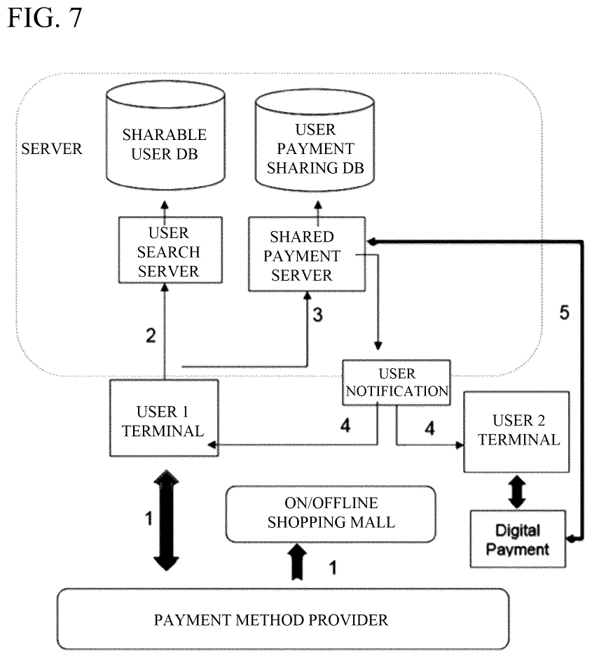

Meanwhile, FIG. 7 illustrates a shared payment system according to still another embodiment of the present invention. To this end, the user terminal 100 according to the embodiment of the present invention may include a benefit information sharing module.

The benefit information sharing module may provide a function in which, when the user of the user terminal 100 visits an affiliated store with friends or family members who are using the same service according to the embodiment of the present invention, a payment method with the greatest payment benefits is automatically found and presented from among the persons who have gone along with the user.

For example, when the user selects an accompanying user using the same service on his/her mobile device, the user terminal 100 according to the embodiment of the present invention may perform processing so that the payment benefit information of the payment method owned by the companion is visible, or when users of the user terminal 100 according to the embodiment of the present invention are connected to the same affiliated store's Wi-Fi, the user terminal 100 according to the embodiment of the present invention may perform processing to output the payment method with the greatest benefit to the mobile terminal. To this end, information on the friend who has previously selected the benefit information sharing function may be pre-registered in the user terminal 100 according to the embodiment of the present invention.

Meanwhile, the user terminal 100 according to the embodiment of the present invention may compare and show the benefits of payment methods other than the payment method held by the user for users who frequently visit a specific online mall or offline store through the benefit information processing unit 160, and thus payment method promotion and consumer rights may be improved.

More specifically, payment sharing and approval may refer to the concept of jointly using the user's card by approving the card to be used online or offline by the user's family members in the economic community. This concept may include a structure that allows friends or others outside the economic community to use the card and requires repayment and additional costs.

For example, when a family payment sharing user only performs a procedure of confirming the shared payment method, shared payments may be permitted in the form of one-time permission, periodic permission, or use permission according to the family use permit. Even when the user uses his/her one card, the user may still earn points on his/her family card. For example, the user may go to Hyundai Department Store and use his/her Woori Card and accumulate points on his/her family's department store-linked Samsung Card/Hyundai Card or a unique family-owned Hyundai Department Store point card.

Further, when this concept is expanded, functions such as approving the use of the user's card for non-family members, usage fees, pre-deposit accounts, and linking other persons' check cards or payment accounts may be further performed.

Referring to FIG. 7 for this purpose, use sharing registration of the user terminal 100 according to the embodiment of the present invention follows the following procedure.

\textcircled{1} The user terminal 100 according to the embodiment of the present invention allows User 1 to select one from among shared payment methods that are recognized in advance by a payment method provider, the selected shared payment method is registered as a shared payment method between the user terminal 100 according to the embodiment of the present invention and the payment method provider (card company), and the payment method provider provides this information to affiliated stores.

\textcircled{2} The user terminal 100 according to the embodiment of the present invention identifies User 2 (payment sharing user) using an ID (phone number) of User 2 according to a request of User 1 (payment sharing provider) and registers User 2 in a sharable user DB. The user terminal 100 according to the embodiment of the present invention performs a personal verification procedure other than the phone number of User 2 as necessary.

\textcircled{3} When User 1 allows User 2 to share the designated payment method (card), the user terminal 100 according to the embodiment of the present invention registers this information in terminals of Users 1 and 2 and a shared payment server.

\textcircled{4} The user terminal 100 according to the embodiment of the present invention outputs the shared payment method to User 1 and 2 as a notification.

\textcircled{5} A digital payment method (Samsung Pay, Naver Pay, etc.) may be built in the terminal of User 2, and is provided to the shared payment server and the user terminal 100 according to the embodiment of the present invention to share and process information on the shared payment method.

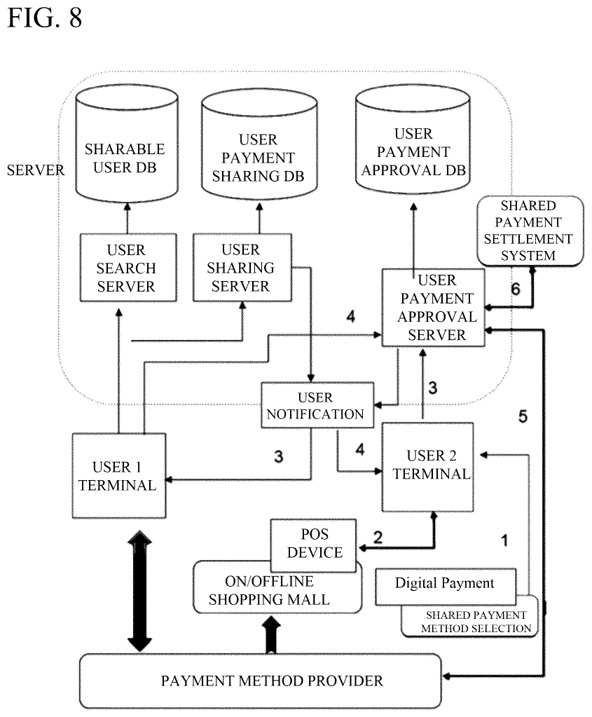

FIG. 8 illustrates a payment system including the user terminal 100 according to the embodiment of the present invention for using a shared payment method.

According to the processing described above in FIG. 7, information that User 2 has paid with the shared payment method is transmitted to a point of sales (POS) of an online/offline store, and when User 2 enters a specific store, the user terminal 100 according to the embodiment of the present invention may output the payment method registered by User 2 and benefits related to the corresponding store (online/offline) of the shared payment method to the mobile terminal of User 2.

\textcircled{1} User 2 may select the shared payment method through an application provided by the user terminal 100 according to the embodiment of the present invention.

\textcircled{2} In order for User 2 to use the shared payment method, payment details should be transmitted to User 1 in advance. To this end, the mobile terminal of User 2 accesses the POS of the store (online/offline), receives payment detail information, and transmits the received payment detail information to User 1. As an example of the method of receiving payment details, a method in which a payment is made with a credit card already in use, a notification of the payment details is received via a text message to the terminal of User 2, and then the user terminal 100 according to the embodiment of the present invention transmits the information to User 1 may be used.

For example, when a digital payment method linked to the POS processes a temporary payment, the payment details are transmitted to the terminal of User 1 through a user payment approval server.

Since the POS and the user terminal 100 according to the embodiment of the present invention are linked, the payment details are transmitted to the terminal of User 1 through the user payment approval server when the shared payment method is selected on the user terminal 100 according to the embodiment of the present invention.

\textcircled{3} The user terminal 100 according to the embodiment of the present invention provides usage request information including the payment details of User 2 to User 1 as a mobile terminal notification. The usage request information includes information such as an amount, an affiliated store, etc.

\textcircled{4} When User 1 inputs a payment password on his/her mobile terminal and approves the password, this information is transmitted to the terminal of User 2 through the user payment approval server.

\textcircled{5} A payment of User 2 is made using the payment method of User 1 upon final approval from the payment method provider.

\textcircled{6} When the payment method is shared with someone outside of one's economic community, a separate online settlement procedure may be established to enable shared payment after another person's advance deposit, or settlement may be made by adding a small fee for shared payment.

Further, since the company that supplies the payment method is linked to the online/offline POS, the user payment approval server of the user terminal 100 according to the embodiment of the present invention may also be linked to the payment method provider. Services with all the sharable payment methods may be performed under prior business agreement with the relevant provider.

Meanwhile, the user terminal 100 according to the embodiment of the present invention may register a personal payment method that is not in a list of payment methods provided by default to the user terminal 100 according to the embodiment of the present invention, and thus the user may first input payment method information and then the user terminal 100 according to the embodiment of the present invention may confirm and formally register the payment method information.

For example, the user terminal 100 according to the embodiment of the present invention pre-registers 10 types of Woori cards, but when there is no “Woori V Biz Card. Golf” for personal use, the user terminal 100 according to the embodiment of the present invention may provide a UI that allows the user to take a photo of the card and input the card name. Thereafter, the user terminal 100 according to the embodiment of the present invention may officially register “Woori V Biz Card. Golf” and update the benefit DB.

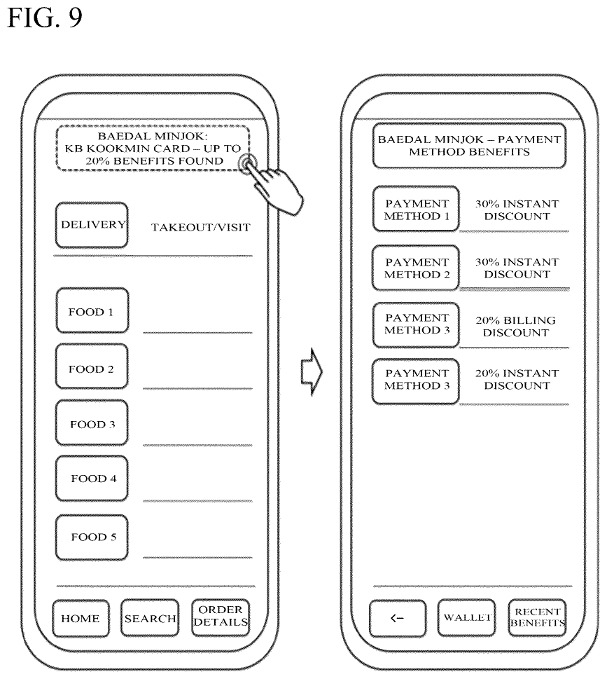

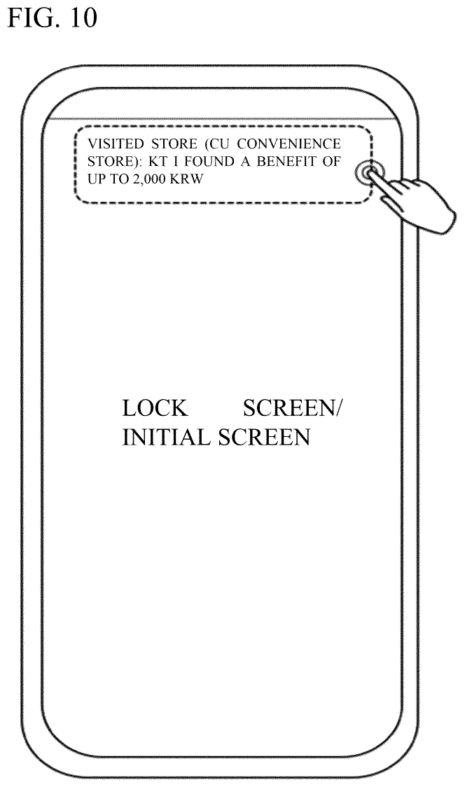

FIGS. 9 and 10 are exemplary diagrams for describing an implementation example of a service interface according to an embodiment of the present invention.

Referring to FIG. 9, the user terminal 100 according to the embodiment of the present invention may provide an automatic notification service when starting the “Baedal Minjok” app or accessing a web service. When a user selects an alarm, the user may move to an application execution screen provided by the user terminal 100 according to the embodiment of the present invention, and card and membership benefit information available in the corresponding app may be provided on a screen.

More specifically referring to FIG. 9, the application provided by the user terminal 100 according to the embodiment of the present invention may be run in the background. In addition, when the “Baedal Minjok” app is executed, a notification of an optimal payment method benefit provided by the user terminal 100 according to the embodiment of the present invention may be displayed at the top of the screen. Thereafter, when the notification of the optimal payment method benefit is selected, the user may move to the application execution screen provided by the user terminal 100 according to the embodiment of the present invention, the card and membership benefit information available in the corresponding app may be provided on the screen, and the remaining benefits for this month for each card may be calculated and output.

FIG. 10 is a diagram for describing the operation of an application provided by the user terminal 100 according to the embodiment of the present invention according to access to an offline store. Referring to FIG. 10, when a user is located near the “CU” store, a Wi-Fi signal identification operation of an application running in the background may be processed, and when the user approaches the “CU” store, the user's approach may be recognized and an automatic notification message may be processed to be output at the top of the screen.

Meanwhile, the methods according to various embodiments of the present invention described above may be implemented in the form of installation data to be executed on a terminal and stored in various non-transitory computer readable media and provided to each server or device. Accordingly, the user terminal 100 may access the server or device and download the installation data.

A non-transitory readable medium is a medium that stores data semi-permanently and can be read by a device, rather than a medium that stores data for a short period of time, such as registers, caches, memories, etc. Specifically, the various applications or programs described above may be stored and provided on non-transitory readable media such as a compact disc read only memory (CD-ROM), a digital video disc (DVD), a hard disk, a Blu-ray disc, a USB, a memory card, a read only memory (ROM), etc.

While exemplary embodiments of the present invention have been illustrated and described above, the present invention is not limited to the above-described specific exemplary embodiments. Those skilled in the art may variously modify the present invention without departing from the gist of the present invention claimed by the appended claims, and such modifications are within the scope of the claims.

1. An operating method of obtaining usage information of a user terminal, which is an operating method of a user terminal, comprising:
obtaining an access request for a target service server;
obtaining domain name server (DNS) lookup request result information corresponding to the target service server using a virtual private network (VPN) module; and
obtaining access domain information from the DNS lookup request result information.

2. The operating method of claim 1, further comprising registering a first address as DNS server information in the VPN module,
wherein the obtaining of the DNS lookup request result information includes obtaining, by the VPN module, the DNS lookup request result information from the DNS server in a form of a User Datagram Protocol (UDP) packet.

3. The operating method of claim 1, wherein the obtaining of the access domain information includes:
filtering notification target domain information from the DNS lookup request result information composed of a UDP packet; and
analyzing a request Internet Protocol (IP) packet to the target service server, and when a number or frequency of requests to a specific domain among domains registered in the notification target domain information is more than or equal to a threshold value, obtaining the access domain information corresponding to the specific domain.

4. The operating method of claim 1, further comprising outputting notification information related to a service corresponding to the access domain information.

5. A user terminal, comprising:
a virtual private network (VPN) module; and
a control unit configured to obtain an access request for a target service server,
wherein the VPN module obtains domain name server (DNS) lookup request result information corresponding to the target service server and obtains access domain information from the DNS lookup request result information.

6. The user terminal of claim 5, wherein the control unit registers a first address as DNS server information in the VPN module, and
the VPN module obtains the DNS lookup request result information from the DNS server in a form of a User Datagram Protocol (UDP) packet.

7. The user terminal of claim 5, wherein the VPN module filters notification target domain information from the DNS lookup request result information composed of a User Datagram Protocol (UDP) packet, analyzes a request Internet Protocol (IP) packet to the target service server, and when a number or frequency of requests to a specific domain among domains registered in the notification target domain information is more than or equal to a threshold value, obtains the access domain information corresponding to the specific domain.

8. The user terminal of claim 7, wherein the control unit outputs notification information related to a service corresponding to the access domain information.

9. A device comprising:
a memory configured to store one or more instructions; and
a processor configured to execute the one or more instructions stored in the memory,
wherein the processor performs the method of claim 1 by executing the one or more instructions.

10. A computer-readable recording medium on which a program for executing a method of claim 1.
